(19) United States
(12) Patent Application Publication
(10) Pub. No.: US 2018/0149333 A1
(43) Pub. Date: May 31, 2018

(54) LOW-PROFILE EFFICIENT VEHICULAR LIGHTING MODULES

(71) Applicant: FORD GLOBAL TECHNOLOGIES, LLC, Dearborn, MI (US)

(72) Inventors: Arun Kumar, Farmington Hills, MI (US); Greg A. Patton, Ypsilanti, MI (US); Bruce Preston Williams, Grosse Pointe Park, MI (US); Martin Witte, Warren, MI (US); Albert Ekladyous, Shelby Twp., MI (US)

(21) Appl. No.: 15/363,052

(22) Filed: Nov. 29, 2016

(51) Int. Cl. F21S 8/10; B60Q 1/20

(52) U.S. Cl. CPC F21S 48/1225; F21Y 2115/10; F21S 48/115; B60Q 1/20

(57) ABSTRACT

A vehicle lighting module includes a silicone lens having an input surface and an exit surface, and a light source. The lens defines a near-zero draft between the input surface and the exit surface. The input surface is configured to shape an incident light emanating from the light source into a collimated light pattern emanating from the exit surface and containing at least 69% of the incident light. For this, the input surface includes a plurality of multi-faceted near-field lens elements each having a different focal length and each defining a near-zero draft. The exit surface includes a plurality of micro-optical elements configured to shape the collimated light pattern into a predetermined emitted light pattern.

### TECHNICAL FIELD

This disclosure relates generally to motor vehicle lighting. More particularly, the disclosure relates to low-profile lighting modules comprising a lens defining a near-zero draft.

### BACKGROUND

Conventional vehicle headlamps such as projector lamps, multi-cavity lamps, and other lighting elements require multiple components such as a light source, light collector, light distributor, etc. Such lighting elements are subject to dimensional constraints associated with the lens shapes required to provide desired collimated lighting patterns, for example low-beams, high-beams, fog lamps patterns, and others. Lens light transmission efficiency is also a design constraint, and conventional vehicle headlamps rarely exceed 50% efficiency, i.e. rarely transmit more than 50% of the light emitted by a light source as a collimated light beam having a desired pattern. Much of the light emitted by the light source is wasted due to poor light collection and destruction of light in the light collector.

Because of this loss of efficiency, headlamps require significant energy usage, equating to higher watt consumption and heat management issues. In turn, smaller profile headlamps meeting regulatory requirements for day/night light intensity, while desirable, cannot be achieved using conventional technology without losing the optical control necessary to control emission of light into desired patterns as described above.

Thus, a need is identified in the art for lighting components allowing such smaller profiles while meeting regulatory requirements for light intensity, and also providing reduced energy usage and light wastage.

### SUMMARY

In accordance with the purposes and benefits described herein and to solve the above-summarized and other problems, in one aspect a vehicle lighting module is provided, comprising a silicone lens having an input surface and an exit surface, the lens defining a near-zero draft between the input surface and the exit surface. The module further includes a light source. The input surface is configured to shape an incident light emanating from the light source into a collimated light pattern emanating from the exit surface and containing at least 69% of the incident light. The input surface comprises a plurality of multi-faceted near-field lens elements each having a different focal length and each defining a near-zero draft. The exit surface comprises a plurality of micro-optical elements configured to shape the collimated light pattern into a predetermined emitted light pattern.

In embodiments, the predetermined emitted light pattern is one of a low-beam lamp pattern, a high-beam lamp pattern, a fog lamp pattern, a daytime running lamp pattern, and a static bending lamp pattern. In embodiments, one or more of the plurality of micro-optical elements are each 2 mm or less in diameter. In other embodiments, one or more of the plurality of micro-optical elements are each 0.5 mm or less in diameter.

In another aspect, a vehicle headlamp assembly is provided, comprising one or more vehicle lighting modules as described above contained in a housing.

In yet another aspect, a lens for a vehicle lighting module is provided, comprising a silicone lens body defining an input surface and an exit surface, the lens body further defining a near-zero draft between the input surface and the exit surface. As described above, the input surface is configured to shape incident light emanating from the light source into a collimated light pattern emanating from the exit surface containing at least 69% of the incident light. To accomplish this, the input surface comprises a plurality of multi-faceted near-field lens elements each having a different focal length and each defining a near-zero draft. The exit surface comprises a plurality of micro-optical elements configured to shape the collimated light pattern into a predetermined emitted light pattern which can be one of a low-beam lamp pattern, a high-beam lamp pattern, a fog lamp pattern, a daytime running lamp pattern, and a static bending lamp pattern.

In embodiments one or more of the plurality of micro-optical elements are each 2 mm or less in diameter. In other embodiments one or more of the plurality of micro-optical elements are each 0.5 mm or less in diameter. The exit surface may define a quadrilateral shape, a circular shape or other shape.

In the following description, there are shown and described embodiments of the disclosed vehicle lighting modules, lenses therefor, and lighting assemblies comprising the modules. As it should be realized, the modules, lenses, etc. are capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed vehicle lighting modules, and together with the description serve to explain certain principles thereof. In the drawing:

FIG. 1A shows a rear view of a lens for a vehicle lighting module according to the present disclosure;

FIG. 1B shows a side view of the lens of FIG. 1A;

FIG. 2A shows a front perspective view of a lens for a vehicle lighting module according to the present disclosure, configured for a low beam application;

FIG. 2B shows a front perspective view of a lens for a vehicle lighting module according to the present disclosure, configured for a high beam application;

FIG. 3 shows a side view of a vehicle lighting module according to the present disclosure;

FIG. 4A shows an embodiment of a headlamp assembly including a pair of vehicle lighting modules according to the present disclosure; and

FIG. 4B shows an alternative embodiment of a headlamp assembly including a pair of vehicle lighting modules according to the present disclosure.

Reference will now be made in detail to embodiments of the disclosed vehicle lighting modules, examples of which are illustrated in the accompanying drawing figures wherein like reference numerals indicate like features.

### DETAILED DESCRIPTION

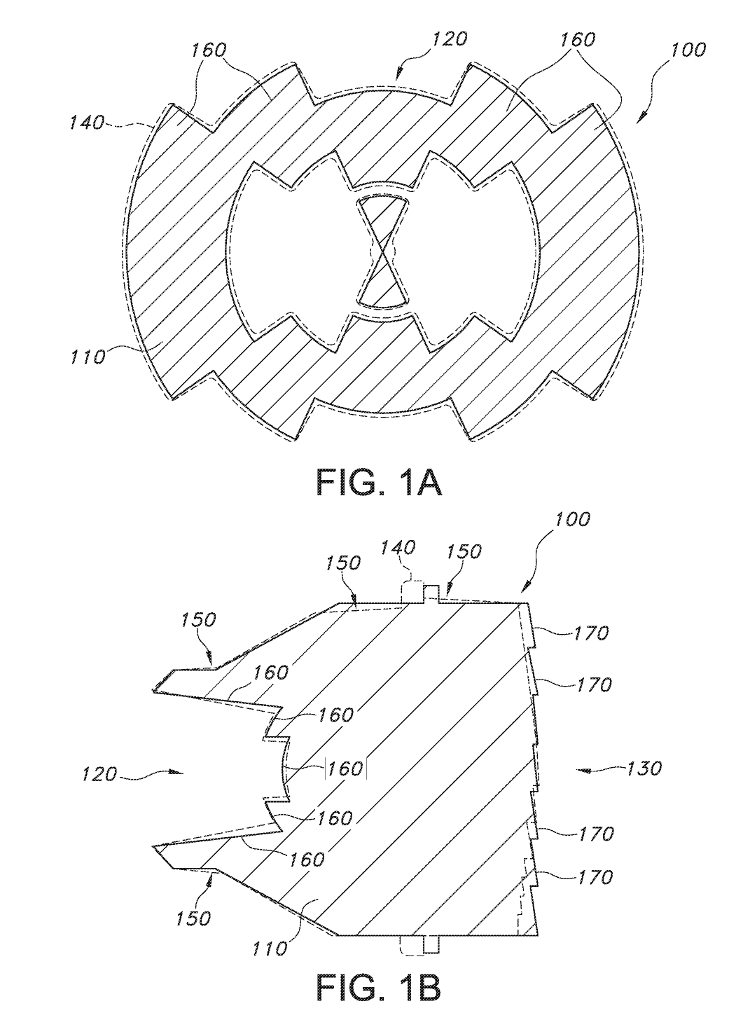

FIGS. 1A-1B depict a lens 100 for a vehicle lighting module according to the present disclosure. The depicted lens is typically fabricated as a unitary body 110 defining an input surface 120 and an exit surface 130. In the depicted embodiment, the unitary body 110 is fabricated of a silicone material. As is known, silicone is an optically translucent material, and indeed provides a better transmission of light than materials conventionally used in fabricating lenses for lighting modules such as polycarbonate, glass, acrylic, and others. In embodiments, suitable silicone grades used in fabricating a lens 100 may have properties of less than 0.002%/mm absorption, a refractive index of approximately 1.41/2, and a diffusion of light of less than 0.1% per incident angle. In one embodiment, the moldable silicone manufactured by Dow Corning (Auburn, Mich.) and marketed under the brand name MS-1002 is suitable for the described applications. However, as will be appreciated other moldable silicones meeting the above parameters are equally suitable, and so this embodiment will not be taken as limiting.

Use of silicone in fabricating a lens 100 confers other unexpected benefits. In particular, because of silicones' properties of flow and curing, it is possible to provide a lens body 110 having a property of near-zero draft. It will be appreciated that as used herein, “near-zero draft” means no or slightly negative draft. As is known, typically some amount of draft, i.e. a positive angle from a horizontal plane, is required in order to safely extract a molded component from a mold. Absent such draft, the molded component may be difficult to extract and may risk damage during the extraction. Because of the draft in the mold walls, a similar draft is created in the exterior of the molded component.

This is illustrated in FIGS. 1A-1B wherein is superimposed in broken lines a silhouette of a lens 140 manufactured from conventional materials such as polycarbonate, acrylic, blends, etc. As shown, the conventional lens 140 includes a number of draft areas 150, which are particularly visible in FIG. 1B. On the other hand, because of silicones' properties of flow and curing, the lens body 110 requires no such draft because the molded body can be ejected by simply squeezing it out of the mold.

This is further advantageous in the vehicle lighting module arts because significant light (up to 5% of collected incident light) is lost in such draft areas 150. Moreover, such draft areas 150 create glare, further increasing the difficulty of lighting module design. Lacking such draft areas, the lens body 110 of the present disclosure allows improved light transmission and reduced light wastage compared to lenses fabricated of conventional materials.

As is known, light emanating from a light source such as a light-emitting diode (LED) exhibits significant scatter, often in a 180 degree radius from a light emitting portion of the light source. For that reason, the lens body input surface 120 is provided with a plurality of multi-faceted near-field lens elements 160, configured to shape an incident light (see arrows) emanating from a light source (not shown) into a collimated light pattern emanating from the exit surface 130. One or more of the multi-faceted near-field lens elements 160 may define focal lengths that differ from the focal lengths defined by others of the multi-faceted near-field lens elements 160, thus working in conjunction to collimate incident light from one or more light sources (not shown in this view). Exemplary, though non-limiting, designs of multi-faceted near-field lens elements 160 for a lens body input surface 120 as described herein are disclosed in U.S. Pat. No. 9,156,395 to the present assignee, Ford Global Technologies, LLC. The disclosure of U.S. Pat. No. 9,156,395 is incorporated by reference in its entirety herein.

By the multi-faceted near-field lens elements 160 and the superior light transmitting properties of the lens body 110 as described, a collimated light pattern emanating from the exit surface 130 containing 69% or more of the collected incident light is provided, significantly exceeding the capabilities of conventional lenses and lighting modules which struggle to provide 50% efficiency. This allows use of smaller light sources to provide a required amount of light emission, saving energy and reducing generation of heat in a lighting module.

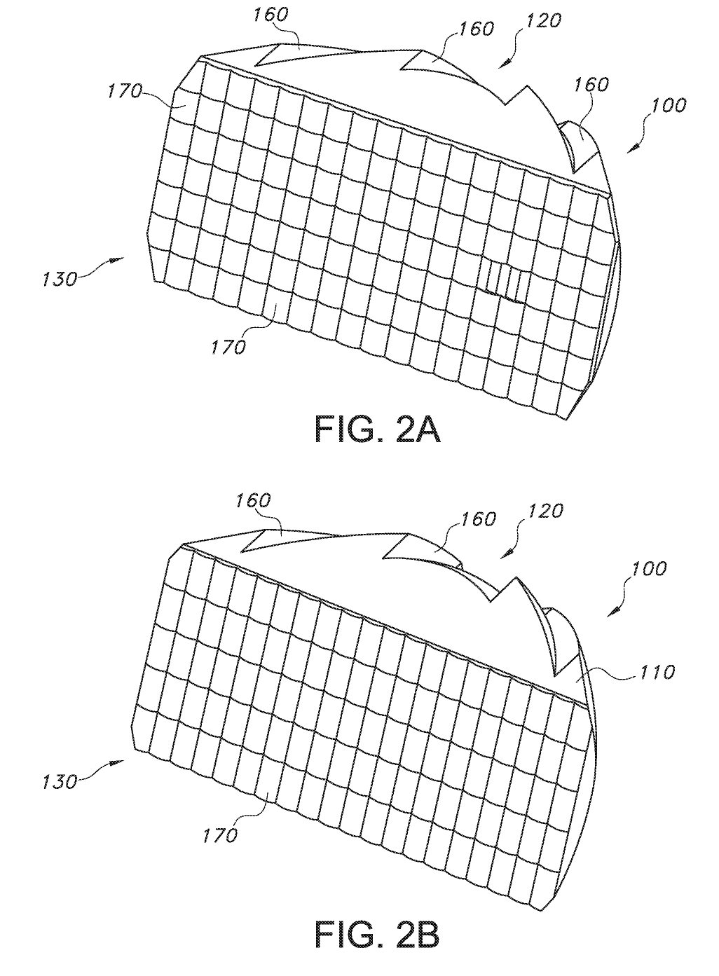

With reference to FIGS. 2A and 2B, the exit surface 130 defines a plurality of micro-optical elements 170 configured to shape the collimated light pattern into a predetermined emitted light pattern. This emitted light pattern may be a low-beam pattern, a high-beam pattern, a fog lamp pattern, a daytime running lamp pattern, a static bending lamp pattern, and others according to the day/night/visibility conditions under which the vehicle lighting module will be operated. This additional benefit is also garnered by the use of silicone to fabricate the lens body 110. By “micro-optics” it is meant optical elements that are significantly smaller in size than traditional optical elements used in vehicle lighting module lenses. For example, micro-optical elements 170 having a width of 2 mm and less, even 0.5 mm or less, are possible by the use of silicone in fabrication.

Such micro-optical elements 170 allow significantly better light beam control and more precise optics. As a non-limiting example, for an exit surface 130 defining an area of 20×20 mm that directs/spreads/wedges emitted light in one direction, the exit surface including 400 micro-optical elements 170 each defining a 1×1 mm area to individually control emitted light direction/spread/wedge, a 400× increase in control of emitted light is realized.

Still more advantages accrue from use of silicone to fabricate a lens body 110. The lenses 100 depicted in FIGS. 2A and 2B are for, respectively, a low beam application and a high beam application, and the micro-optical elements 170 are configured accordingly. Because of the improved collection and transmission of light provided by the lens body 110 as described above, the dimensions of the lens body can be significantly reduced. In the non-limiting example depicted in FIG. 2A, a lens 100 for a low beam application is provided having a dimension of approximately 90 mm wide, 45 mm height, and 50 mm depth. In the non-limiting example depicted in FIG. 2B, a lens 100 for a high beam application is provided having a dimension of approximately 80 mm wide, 40 mm height, and 47 mm depth.

This can be compared to the dimensions of, for example, a conventional projection beam lighting module wherein the lens has dimensions of 70 mm diameter and 200 mm depth. This allows creation of lighting modules having a significantly smaller size which still provide light emission at the strength, distance, and light spread patterns required by various regulatory agencies, but at a significantly reduced energy cost and heat emission. While newer LED-based projection beam lighting modules may be smaller (for example, 130 mm depth and 50-60 mm aperture), such LED-based modules still require complexity in design (reflectors, shields, and other mechanisms in addition to a lens) compared to crystal designs such as are described herein.

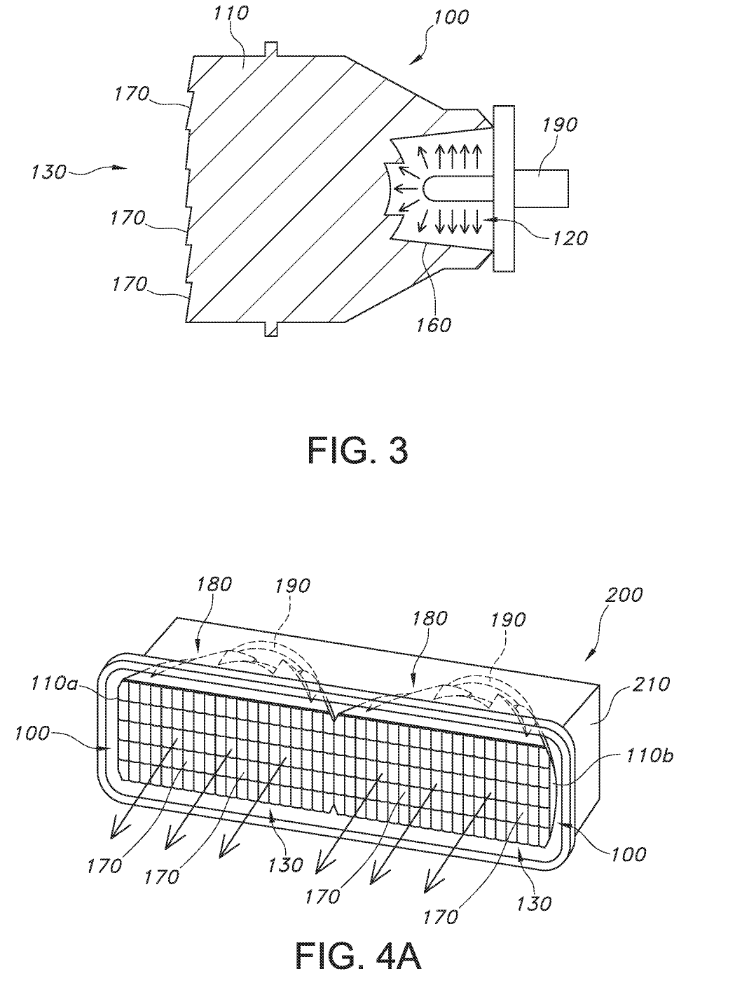

FIG. 3 illustrates a representative vehicle lighting module 180 including one or more lenses 100 as described above, and a light source such as an LED lamp 190 disposed to emit light which can be collected by the input surface 120 as described above. As discussed, light emitted from the LED lamp 190 scatters on a 180 degree radius. By the multi-faceted near-field lens elements 160, that scattered light is collected and transmitted efficiently through the lens body 110 in part due to the near-zero draft feature described above. By the described multi-faceted near-field lens elements 160, collimation of incident light down to approximately 3 degrees is made possible. The collimated light pattern exits through the exit surface 130, shaped into the desired beam pattern by micro-optical elements 170.

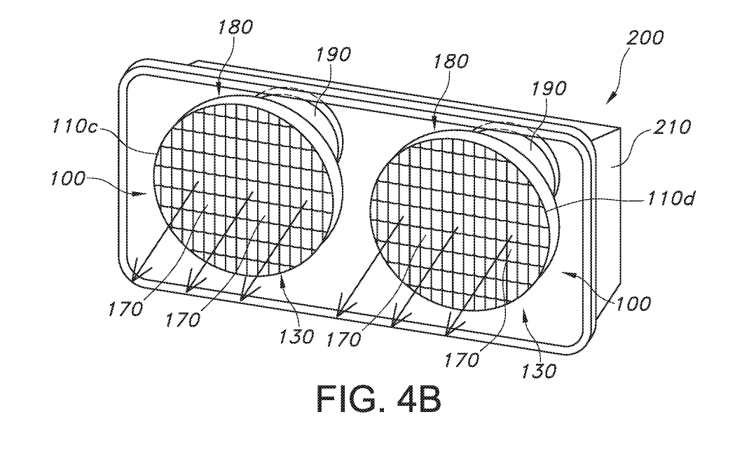

FIGS. 4A and 4B illustrate headlamp assemblies 200 including the vehicle lighting modules 180 described above. FIG. 4A shows a headlamp assembly 200 includes a housing 210 holding a pair of lighting modules 180. One module 180 includes a lens body 110a configured as a low beam headlight and the other module includes a lens body 110b configured as a high beam headlight. This is done by the micro-optical elements 170 configuration as described above.

Each lens body 110a, 110b includes an exit surface 130 defining a quadrilateral shape for emitting a collimated light pattern (see arrows). In conventional lighting modules, such quadrilateral exit surface shapes result in significant losses in light transmission efficiency. By the features and benefits described above, such losses in efficiency are avoided and use of more compact quadrilaterally shaped lenses 100 and headlamp assemblies 200 is made possible. However, as will be appreciated use of lens bodies 110 including exit surfaces 130 defining circular shapes is also contemplated.

This is illustrated in FIG. 4B, showing a headlamp assembly 200 including a housing 210 holding a pair of lighting modules 180 including lenses 100 having exit surfaces 130 defining circular shapes. One module 180 includes a lens body 110c configured as a low beam headlight and the other module includes a lens body 110d configured as a high beam headlight. Again, these lighting patterns are accomplished by the micro-optical elements 170 configuration as described above.

By the above-described features, lenses 100 exhibiting superior light transmission efficiency are provided. In one example, a lens 100 was incorporated into a lighting module 180 including an LED lamp 190 emitting light at 1250 lumens. The lens 100 provided a collimated light pattern output of 860 lumens, which represents 69% light transmission efficiency. In another example, a lens 100 was incorporated into a lighting module 180 including an LED lamp 190 emitting light at 1250 lumens. The lens 100 provided a collimated light pattern output of 900 lumens, which represents 72% light transmission efficiency.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A vehicle lighting module, comprising:
a silicone lens having an input surface and an exit surface, the lens defining a near-zero draft between the input surface and the exit surface; and
a light source;
wherein the input surface is configured to shape an incident light emanating from the light source into a collimated light pattern emanating from the exit surface and containing at least 69% of the incident light.

2. The vehicle lighting module of claim 1, wherein the input surface comprises a plurality of multi-faceted near-field lens elements each having a different focal length and each defining a near-zero draft.

3. The vehicle lighting module of claim 1, wherein the exit surface comprises a plurality of micro-optical elements configured to shape the collimated light pattern into a predetermined emitted light pattern.

4. The vehicle lighting module of claim 3, wherein the predetermined emitted light pattern is one of a low-beam lamp pattern, a high-beam lamp pattern, a fog lamp pattern, a daytime running lamp pattern, and a static bending lamp pattern.

5. The vehicle lighting module of claim 3, wherein one or more of the plurality of micro-optical elements are each 2 mm or less in diameter.

6. The vehicle lighting module of claim 3, wherein one or more of the plurality of micro-optical elements are each 0.5 mm or less in diameter.

7. A vehicle headlamp assembly, comprising:
one or more vehicle lighting modules, each module comprising a silicone lens defining a near-zero draft between an input surface and an exit surface, and a light source; and
a housing for the one or more vehicle lighting modules;
wherein the input surface comprises a plurality of near-field lens elements configured to shape an incident light emanating from the light source into a collimated light pattern emanating from the exit surface and containing at least 69% of the incident light.

8. The vehicle headlamp assembly of claim 7, wherein the input surface comprises a plurality of multi-faceted near-field lens elements each having a different focal length and each defining a near-zero draft.

9. The vehicle headlamp assembly of claim 7, wherein the exit surface comprises a plurality of micro-optical elements configured to shape the collimated light pattern into a predetermined emitted light pattern.

10. The vehicle headlamp assembly of claim 9, wherein the predetermined emitted light pattern is one of a low-beam lamp pattern, a high-beam lamp pattern, a fog lamp pattern, a daytime running lamp pattern, and a static bending lamp pattern.

11. The vehicle headlamp assembly of claim 9, wherein one or more of the plurality of micro-optical elements are each 2 mm or less in diameter.

12. The vehicle headlamp assembly of claim 9, wherein one or more of the plurality of micro-optical elements are each 0.5 mm or less in diameter.

13. A lens for a vehicle lighting module, comprising a silicone lens body defining an input surface and an exit surface, the lens body further defining a near-zero draft between the input surface and the exit surface;
wherein the input surface is configured to shape incident light emanating from a light source into a collimated light pattern emanating from the exit surface containing at least 69% of the incident light.

14. The lens of claim 13, wherein the input surface comprises a plurality of multi-faceted near-field lens elements each having a different focal length and each defining a near-zero draft.

15. The lens of claim 13, wherein the exit surface comprises a plurality of micro-optical elements configured to shape the collimated light pattern into a predetermined emitted light pattern.

16. The lens of claim 15, wherein the predetermined emitted light pattern is one of a low-beam lamp pattern, a high-beam lamp pattern, a fog lamp pattern, a daytime running lamp pattern, and a static bending lamp pattern.

17. The lens of claim 15, wherein one or more of the plurality of micro-optical elements are each 2 mm or less in diameter.

18. The lens of claim 15, wherein one or more of the plurality of micro-optical elements are each 0.5 mm or less in diameter.

19. The lens of claim 13, wherein the exit surface defines a quadrilateral shape.

20. The lens of claim 13, wherein the exit surface defines a circular shape.
